(19) United States
(12) Patent Application Publication
(10) Pub. No.: US 2002/0188859 A1
(43) Pub. Date: Dec. 12, 2002

(54) DNA intrusion detection method

(76) Inventor: James Terry Dollens, Roswell, GA (US)

Correspondence Address: JAMES TERRY DOLLENS, 1675 COX RD, ROSWELL, GA, 30075, US

(21) Appl. No.: 09/681,804

(22) Filed: Jun. 7, 2001

(51) Int. Cl. G06F 11/30; G06F 12/14

(52) U.S. Cl. 713/200

(57) ABSTRACT

Knowing that an object does not belong to an authorized set of objects is an important step in intrusion detection. Dr. Stephanie Forrest of the University of New Mexico compared the process of computer system defense to the process used by living organisms to defend against diseases, viruses and other foreign agents. Dr. Forrest's thesis was to develop a methodology for identifying the self to use intrusion detection to detect non-self agents. An alternative to this external view is a system that contains its own self-defense mechanism. This method demonstrates that an internal function can be used to differentiate between self and non-self agents. This method will insert identification data into an object that will uniquely connect an object to the operating system on which it resides. This DNA pattern will serve to create a unique copy of the object and create an ownership token between the object and the operating system.

### SUMMARY OF INVENTION

Loscocco, Smalley, Muckelbauer, Taylor, Turner and Farrell (2000) stated that no single technical security solution could provide total system security; a proper balance of security mechanisms must be achieved. Each security mechanism provides a specific security function; and should be designed to only provide that function. It should rely on other mechanisms for support and for required security services. In a secure system, the entire set of mechanisms complement each other so that they collectively provide a complete security package. Systems that fail to achieve this balance will be vulnerable.

Current art of intrusion detection focuses on signature examination or cataloguing patterns of self behavior so that non-self activity can be detected. It is the goal of the present invention to provide a method of “creating self-objects to allow the system to identify non-self objects.”

The DNA Intrusion Detection Method is organized into three general phases. The DNA Definition phase defines the DNA Pattern, the environment in which it belongs, the process for injecting it into the objects, and a storage facility designated as the External Data Storage Structure (EDSS). The DNA Creation phase injects the DNA Pattern into the computer system objects, creates a database of new objects and creates an information database. The DNA Authentication phase authorizes an object for execution by the computer system. The processes in the DNA Definition phase are executed once while the DNA Creation and DNA Authentication phases are executed continuously as new objects are encountered and existing objects are prepared for execution.

Selected objects processed through the DNA Creation phase contain identifiers that connect them to a unique DNA Scope Set. Execution of those objects is accomplished only through the DNA Authentication phase. While this method does not restrict forces from placing unauthorized objects in the system, it will trap those objects and allow the system administrators to review and analyze them prior to execution.

### DETAILED DESCRIPTION

### BACKGROUND

Denning (1999) stated that the use of standard protocols allows interoperability across networks. While this facilitates communication and sharing, it also has drawbacks. Vulnerabilities can be pervasive across computer platforms and organizations, allowing thousands of systems to be swept up in a single attack.

Loscocco et al. (2000) stated that the increased awareness of the need for security has resulted in increased of efforts to add security to computing environments. However, these efforts suffer from the flawed assumption that security can be provided adequately in an application space without certain security features in the operating system. In reality, operating system security mechanisms play a critical role in supporting security at higher levels.

Amoroso (1999) described signatures of abnormal behavior to detect possible intrusions. Some intrusion detection indicators are repetition of a suspicious action; mistyped commands or responses during an automated sequence; exploitation of known vulnerabilities; directional inconsistencies in inbound or outbound packets; unexpected attributes of some service request or packet; unexplained problems in some service request, system, or environment; and suspicious character traffic on a network. Even when a computer system is equipped with stringent authentication procedures and firewalls it is still susceptible to hackers who take advantage of system flaws and social engineering tricks (Goan, 1999). Goan continued, stating that the most obvious conclusion that can be drawn from two decades of research is that there are no easy answers, no silver bullets. Effective intrusion detection capability remains elusive as computing environments become more complex and crackers continually adapt their techniques to overcome innovations in computer security. Additionally, network administrators have been slow to adopt intrusion detection technology due to, among other reasons, excessively high false alarm rates associated with existing tools. These false alarms require a high degree of human analysis, thus reducing existing intrusion detection systems to the status of simple evidence sources. Given this observation, further advances in automated intrusion detection will require the development of new means of exploiting available evidence.

Computer viruses, worms and other devices are able to penetrate computer systems by becoming part of an operating system, application or data. When executed, these unauthorized agents have the potential to damage the host system and, using the authority of the host system, penetrate other systems. Password sub-systems, firewall sub-systems, intrusion detection systems and encryption, which are used to protect computer systems, are external agents that are designed to encapsulate the operating system, applications and data protecting them from intrusion. Dr. Stephanie Forrest of the University of New Mexico compared the process of computer system defense to the process used by living organisms to defend against diseases, viruses and other foreign agents (Forrest, Hofmeyr & Somayaji, 1997). Her thesis was to develop a methodology for identifying the self to use intrusion detection to detect non-self agents. Dr. Forrest suggested procedures for identifying the self by observing patterns of behavior of the system. An alternative to this external view is an operating system that contains its own self-defense mechanism.

This method creates a self-identity organization enabling the operating system to identify foreign agents automatically. This method will allow insertion of identification data into an object to identify uniquely the object to the operating system. This identification data is defined as a DNA Pattern, which is a sequence of identifier fields. Embedding an operating system DNA pattern into an object will differentiate it from all other objects of the same function in other operating system locations. Creation of a self-object will allow the system to identify foreign (or non-self) objects that were copied to the system without going through the DNA insertion process. This would eliminate viruses and Trojan horses from being executed without prior authorization.

### DESCRIPTION OF INVENTION

This following terms will be used in this section:

DNA Domain: An environment where computer system objects reside.

DNA Domain Administrator: An individual or group responsible for authorizing new objects to enter the DNA Domain.

DNA Object: A computer system's executables and non-executables that reside in the DNA Domain.

DNA Pattern: A sequence of identifier fields that will serve to create a unique copy of the object and create an ownership token between the object and the operating system; a collection of DNA Object properties that differentiate one DNA Scope Set from another in the DNA Domain.

DNA Scope Set: The set of DNA Objects residing in the DNA Domain having the same DNA Pattern.

DNA Scope Set Administrator: An individual or group responsible for authorizing new objects to enter the DNA Scope Set. Objects could be moved to the DNA Scope without the DNA Scope Set Administrator's authorization, but the DNA Intrusion Detection process will trap the unauthorized object before it's execution by the central processing unit (CPU).

DNA Steganographic Object: A DNA Object containing a DNA Steganographic Zone.

DNA Steganographic Zone: An area containing the DNA Pattern that is inserted into a DNA Object and is similar in appearance to the DNA Object.

### DNA Definition Phase

This phase establishes the infrastructure of the DNA Intrusion Detection Method and is accomplished by completing five processes:

1. Define the DNA Domain and DNA Scope Set (Process D1)

2. Establish the DNA Pattern (Process D2)

3. Define a Data Hiding Pattern (Process D3)

4. Define the Process for Injecting the DNA Steganographic Zone into the DNA Object (Process D4)

5. Define the EDSS (Process D5)

1. Define the DNA Domain and DNA Scope Set (Process D1)

A computer system's executables and non-executables are defined as DNA Objects. The DNA Scope Set is defined as the set of DNA Objects having the same DNA Pattern. The DNA Domain is defined as an environment where multiple DNA Scope Sets co-exist. The DNA Pattern, therefore, is defined as a collection of DNA Object properties that differentiate one DNA Scope Set from another in the DNA Domain.

### EXAMPLE #1

A simple example is a single stand-alone personal computer with an operating system and three application systems. Each application system has an exclusive set of DNA Objects. In addition, the operating system has its own set of DNA Objects. The DNA Domain, therefore, is defined as the entire set of objects across all the application systems and the operating system. Four DNA Scope Sets are defined: three for the application systems and one for the operating system. Likewise, there are four DNA Patterns in a one-to-one correspondence with a DNA Scope Set. An intrusion detection system using this organizational structure would be in a position to identify any object that was not previously approved by an authorized system user.

Let each aᵢ, for i=1 to k, be a DNA Object of application system A. Then the DNA Scope Set of objects for application system A={a ₁, a₂, a₃, . . . aₖ}.

Let each bᵢ, for i=1 to l, be a DNA Object of application system B. Then the DNA Scope Set of objects for application system B={b₁, b₂, b₃, . . . bₗ}.

Let each cᵢ, for i=1 to m, be a DNA Object of application system C. Then the DNA Scope Set of objects for application system C={c₁, c₂,c₃, . . . cₘ}.

Let each oᵢ for i=1 to n be a DNA Object of the operating system. Then the DNA Scope Set of objects for the operating system O={o₁, o₂, o₃, . . . , oₙ}.

The DNA Domain is the union of the four sets of objects: {A, B, C, O}

### EXAMPLE #2

There may be a situation where the operating system contains a set of shared DNA Objects that can be used by all of the application systems. Using the definitions from example #1, let the shared set of operating system DNA Objects be{o₃, o₄, o₅}.

Then in this example the DNA Domain would be the same as in example #1, but the DNA Scope Sets for A, B and C would be expanded to include the three operating system DNA Objects.

A={a₁, a₂, a₃, . . . aₖ, o₃, o₄, o₅}

B={b₁, b₂, b₃, . . . bₗ, o₃, o₄, o₅}

C={c₁, c₂, c₃, . . . cₘ, o₃, o₄, o₅}

This is an example where computer systems violate the biological metaphor.

### EXAMPLE #3

In another example, the designer may want to limit objects requiring a DNA Pattern. This may be due to system constraints, such as execution time or an application having a low risk of infection. If, from example #2, objects b₃, b₄ and b₅ from application system B do not require a DNA Pattern then the DNA Scope Set for B={b₁, b₂, b₆bₗ, o₃, o₄, o₅} while the DNA Scope Sets for A, C and O would not change.

2. Establish the DNA Pattern (Process D2)

The objective of this process is to define a set of object properties that will create a unique identity for objects across the entire DNA Domain. That is, if multiple systems are to be defined in a DNA Domain, the DNA Pattern of each system must be unique establishing a one-to-one correspondence between an object and a system in a DNA Domain. Some property examples are the system URL, the application's time-date stamp, the operating system code name, an application system code name or a hash code.

Let each dᵢ for i from 1 to k be a property of a DNA Object for a given DNA Scope Set. Then a unique DNA Pattern is defined as a subset of those properties when compared to DNA Patterns of other DNA Scope Sets in the DNA Domain. For example, if {d₁, d₂, dₖ} represents a set of DNA Object properties then a DNA Pattern may be defined as the set {d₅, d₈, d₁₂} such that their property values in combination create a unique code across the DNA Domain.

Implementation of the DNA Pattern could be a string concatenation of the individual property values: d₅+d₈+d₁₂. From example #1 in process D1, the DNA Domain consists of four DNA Scope Sets (systems) resident on a single computer. Assume the CPU serial number is CPU73 and the names of the four DNA Scope Sets (three application systems and one operating system) are AA22, AB36, AC07 and ON12. A DNA Pattern can be defined as a string concatenation of the CPU serial number and the DNA Scope Set name. That is the four DNA Patterns are:

DNA Pattern for DNA Scope Set A=CPU73AA22

DNA Pattern for DNA Scope Set B=CPU73AB36

DNA Pattern for DNA Scope Set C=CPU73AC07

DNA Pattern for DNA Scope Set O=CPU73ON12

3. Define a Data Hiding Pattern (Process D3)

There are two objectives of this process (D3) and the next process (D4): (1) to hide the DNA Pattern in the DNA Object and (2) to achieve the first objective while minimizing system overhead. Hiding the DNA Pattern in the DNA Object will deter its identification by a malicious intruder. The amount of effort expended to hide the DNA Pattern, however, will have an impact on system overhead because the hiding process is reversed during the DNA Authentication phase.

Process D3 defines the a steganographic procedure for hiding the DNA Pattern in a DNA Steganographic Zone, which is defined as a new area that will be inserted into a DNA Object. The DNA Steganographic Zone must be crafted to be similar in appearance to the DNA Object. For example, if a DNA Object is an executable then the DNA Steganographic Zone would contain what would appear to be machine code instructions.

Let each dᵢ for i from 1 to k be a property of a DNA Object selected to be in the DNA Pattern.

Let D represent the DNA Pattern set: D={d₁, d₂, d₃, . . . , dₖ}.

Let each wᵢ for i from 1 to l be a subset of a representative generic zone that is similar in appearance to the DNA Object.

Let W represent that generic zone set: W={w₁, w₂, w₃, . . , wₗ}. Then the DNA Steganographic Zone, designated as W′, is the union of D and W, where the elements of the set D are dispersed across W.

That is: W′={w₁, w₂w₃, . . . , ,wₗ, d₁, d₂, d₃, . . . , dₖ}

For example, if the elements of D and W are strings then W′ could be defined as a concatenation of those strings: W′=w₁+d₁+w₂+d₂+w₃+d₃+ . . . +wₖ+dₖ+wₖ₊₁+wₖ₊₂+ . . . +wₗ where l>k.

Note that the minimum size of W′ will be D with W defined as a null set. Larger DNA Steganographic Zones could be defined based on the efficiency of the extraction process. If l is much larger than k then the DNA Pattern can be hidden among the innocuous data. That is, if the size of D is small relative to W, then D could be hidden by breaking it up into pieces and distributing it across W creating a form of a subliminal channel. Also note that, prior to creating W′, W could be reorganized as new elements. This, however, would add another step to the creation/authentication phases.

Depending upon the nature of the system, the designer may want to encrypt the DNA Pattern prior to inserting it into the DNA Steganograpic Zone. Cryptography provides functions that encrypt and decrypt data. For example, let function f be an encryption function, let x represent the data, which is called cleartext, to be encrypted, and let x′ be the results of the encryption function. Then x′=f(x), which is known as ciphertext. Cryptography developed a function, denoted as g, that reverses the effect of f on x such that: x=g (f(x)). The example from above with the elements of D encrypted would be displayed as: W′=w₁+f(d₁)+w₂+f(d₂)+ . . . +wₖ+f(dₖ)+wₖ₊₁+wₖ₊₂+ . . . +wₗ where l>k.

4. Define the Process for Injecting the DNA Steganographic Zone into the DNA Object (Process D4)

Execution of this process inserts the DNA Steganographic Zone (designated as W′) into the DNA Object (designated as P) to create the DNA Steganographic Object (designated as P′). This is another set operation where P′ is the union of W′ and P.

Let each pᵢ for i from 1 to p be a subset of the DNA Object.

Let P represent the DNA Object set: P={p₁, p₂, p₃, . . . , pₚ}.

In addition, from above the DNA Steganographic Zone is defined as:

W′={w₁, w₂, w₃, . . . , wₗ, d₁, d₂, d₃, . . . , dₖ}

Then P′ is the DNA Steganographic Object set

P′={p₁, p₂, p₃, . . . , pₚ, w₁w₂, w₃, . . . , wₗd₁, d₂d₃, . . . , dₖ}

If these set elements are strings then P′ could be defined as a concatenated string:

P′=p₁+p₂+p₃+ . . . +pᵢ+w₁+d₁+w₂+d₂+w₃+d₃+ . . . +wₖ+dₖ+wₖ₊₁+wₖ₊₂+ . . . +wₗ+pᵢ₊₁+pᵢ₊₂+pᵢ₊₃+ . . . +pₚ

The combined effect of processes D3 and D4 is to define a new DNA Steganographic Object (P′) that is the combination of the original DNA Object (P), the generic zone set (W) and the DNA Pattern (D). In summary, P′ is the union of the sets P, W and D. If implemented as character strings then the DNA Pattern, which may be encrypted, is split into pieces and inserted into a DNA Steganographic Zone, and the DNA Steganographic Zone is split into pieces and inserted into the DNA Object creating the DNA Steganographic Object.

5. Define the EDSS (Process D5)

The primary purpose of the EDSS is to maintain the list of DNA Steganographic Objects and, at minimum, this structure would contain the DNA Steganographic Object names and the DNA Pattern. The EDSS may also be used to store key information related to the definitions created during the DNA Creation phase. This information will be used in the DNA Authentication phase to extract the DNA Pattern and DNA Object from the DNA Steganographic Object. Key items stored would be the DNA Pattern, or the decryption key of the DNA Pattern if encrypted; the location and embedding configuration of the DNA Steganographic Zone in the DNA Steganographic Object; and the location and embedding configuration of the DNA Pattern in the DNA Steganographic Object.

For example, if P′ is defined as the following character string: P′=p₁+p₂+p₃+ . . . +p_{i +w}₁+d₁w₂+d₂+w₃+d₃+ . . . +wₖ+dₖ+wₖ₊₁+w ₖ₊₂+ . . . +wₗ+pᵢ₊₁+pᵢ₊₂+pᵢ₊₃+ . . . +pₚ the system would need to know the starting address of the Steganographic Zone (w₁) and its length in order to extract it from the DNA Steganographic Object. Also, each wᵢ must contain the address and length of the next one (wᵢ₊₁)

### DNA Creation Phase

Once the environment has been established, through the DNA Definition phase, the system and its administrator can now use the DNA Creation phase to inject the appropriate DNA Pattern into selected objects of the DNA Domain. The DNA Creation phase injects DNA Objects from the DNA Domain with the DNA Pattern and creates the DNA Scope Set consisting of DNA Steganographic Objects. The six tasks of this phase are summarized below:

1. Select a DNA Object from the DNA Domain

2. Retrieve the DNA Pattern from the EDSS

3. Insert the DNA Pattern into a DNA Steganographic Zone based on the data hiding pattern specified in D3

4. Insert the DNA Steganographic Zone into the DNA Object based on the data hiding pattern specified in D4

5. Store the DNA Steganographic Object in the system resource library, and move the original DNA Object off-line

6. Store the DNA Object's control information in the EDSS

1. Select a DNA Object from the DNA Domain

This methodology enables a two-stage authorization of new objects. An object must first enter the DNA Domain where the DNA Domain Administrator approves its movement into the DNA Domain becoming a DNA Object. The second stage authorization is performed by the DNA Scope Set Administrator who authorizes the object to be part of the DNA Scope Set. Input to this phase is a DNA Object and output is a DNA Steganographic Object.

2. Retrieve the DNA Pattern from the EDSS

The DNA Creation phase identified certain properties of the each DNA Object to consist of the DNA Pattern. This task retrieves the DNA Pattern from the EDSS. Another security level may be designed into this process by encrypting the DNA Pattern before storing it on the EDSS, which would have been defined during the DNA Creation phase.

3. Insert the DNA Pattern into a DNA Steganographic Zone based on the data hiding pattern specified in D3

Process D3 of the DNA Design phase may require the DNA Pattern (or its encrypted version) to be split into subsets. In addition, the same process defined how to embed the DNA Pattern into a generic steganographic zone creating the DNA Steganographic Zone. This task performs that function.

4. Insert the DNA Steganographic Zone into the DNA Object based on the Data Hiding Pattern Specified in D4

Process D4 of the DNA Design phase may also require that the DNA Steganographic Zone be split into subsets. In addition, the same process defined how to embed the DNA Steganographic Zone into the DNA Object creating the DNA Steganographic Object. This task performs that function.

5. Store the DNA Steganographic Object in the System Resource Library, and Move the Original DNA Object off-line

A new form of the DNA Object, the DNA Steganographic Object, is now unique across the DNA Domain. The DNA Steganographic Object is moved to the system resource library. The unprotected version of the executable, the DNA Object, should be moved off-line to a secured location so that an unauthorized process cannot execute it on this CPU.

6. Store the DNA Object's Control Information on the EDSS

The DNA Authentication phase will need several essential elements to extract the DNA Pattern from the DNA Steganographic Zone as well as recreating the DNA Object. Those elements are stored in the EDSS.

### DNA Authentication Phase

This phase extracts the DNA Pattern from the DNA Steganographic Object and compares it to what the DNA Pattern should be, which is stored on the EDSS. Matched (authenticated) objects are forwarded to the operating system for processing. Notification is forwarded to the system“s administrator when unmatched objects are requested for execution. This process occurs in real-time and takes place just prior to the object“s execution. An object that successfully completes this phase will be sent to other operating system components for execution. The four tasks are summarized below:

1. Locate the EDSS record and DNA Steganographic Object

2. Extract the DNA Steganographic Zone from the DNA Steganographic Object recreating the DNA Object

3. Extract the DNA Pattern, which may be encrypted, from the DNA Steganographic Zone

4. Compare the extracted DNA Pattern to the system's definition of the DNA Pattern

1. Locate the EDSS record and DNA Steganographic Object

Given a request to execute an object through the normal operating system and application security processes, the EDSS record corresponding to the object“s name is retrieved. It contains key information for extracting the DNA Steganographic Zone from the DNA Steganographic Object and the DNA Pattern from the DNA Steganographic Zone. If the object is not found on the EDSS or the DNA Steganographic Object is not found, then this request is suspect and the DNA Scope Set Administrator is notified. This may be a new authorized object, which will need to be sent to the DNA Creation phase for processing. If not, the DNA Scope Set Administrator has the option to reject the object or begin an analysis to find out more information about the object.

2. Extract the DNA Steganographic Zone from the DNA Steganographic Object recreating the DNA Object

Given the control information on the corresponding EDSS record, specifically the starting location of the DNA Steganographic Zone and its disbursement pattern across the DNA Steganographic Object, the DNA Steganographic Zone is extracted from the DNA Steganographic Object. This process also recreates the DNA Object.

3. Extract the DNA Pattern, which may be Encrypted, from the DNA Steganographic Zone

The EDSS record also contains the disbursement pattern and, if encrypted, the decryption key of the DNA Pattern in the DNA Steganographic Zone.

4. Compare the Extracted DNA Pattern to the System's Definition of the DNA Pattern

The system is ready to compare the DNA Pattern extracted from the DNA Steganographic Object with the original DNA Pattern. For DNA Patterns that match, the system recognizes the object as self and authorizes the DNA Object for execution. For the DNA Patterns that do not match, the object is treated as a non-self object and the DNA Scope Set Administrator is notified. The owner may want to add this new object to the DNA Scope Set or begin an analysis procedure to find out more information about the object.

### References

Amoroso, E. (1999). Intrusion Detection. An Introduction to Internet Surveillance, Correlation, Trace Back, Traps, and Response. Sparta, N.J. Intrusion.Net Books.

Anonymous. (1998). Maximum Security.: A Hacker“s Guide to Protecting Your Internet Site and Network. Second Edition. Indianapolis, Ind. Sams Publishing.

Denning, D. E. (1999). Information Warfare and Security. Reading, Mass. Addison-Wesley.

Forrest, S., Hofmeyr, S., & Somayaji, A. (1997). Computer immunology. Communications of the ACM, 40 (10), 88-96.

Goan, T. (1999, July). A cop on the beat: Collecting and appraising intrusion evidence. Communications of the ACM, 42 (7), 46-52.

Kahn, D. (1996). The Codebreakers: The Story of Secret Writing. New York, N.Y. Scribner.

Loscocco, P. A., Smalley, S. D., Muckelbauer, P. A., Taylor, R. C., Turner, S. J. &, Farrell, J. F. Oct. 17, 2000. The inevitability of failure: The flawed assumption of security in modern computing environments. National Security Agency. http://www.esecurityonline.com/library/whitepapers2.asp

Petitcolas, F. A. P. (1999) Introduction to information hiding. In S. Katzenbeisser & F. A. P. Petitcolas (Eds.), Information Hiding Techniques for Steganography and Digital Watermarking, 1-14. Boston, Mass. Artech House.

Schneier, B. (1996). Applied Cryptography.: Protocols, Algorithms, and Source Code in C. (2^{nd} ed.). New York, N.Y. John Wiley & Sons.

I claim:

1. A method for intrusion detection of a computer system that identifies prior to execution computer system objects that have been changed or new objects added by unauthorized entities. Said method comprises the phases of definition, creation and authentication.

2. The method of claim 1, further comprising the steps of the intrusion detection environment definition.

3. The method of claim 2, wherein comprises the step of defining the DNA Domain, which is the environment where computer system objects reside, and is managed by the DNA Domain Administrator, who is an individual or group responsible for authorizing new objects to enter the DNA Domain.

4. The method of claim 2, wherein comprises the step of defining the DNA Scope Set, which is a set of objects, coined DNA Objects, residing in the DNA Domain having the same DNA Pattern, which is defined in method 6.

5. The method of claim 2, wherein comprises the step of defining an external data storage structure (EDSS) that is a container for control information for the intrusion detection system.

6. The method of claim 2, wherein comprises the step of defining the DNA Pattern, which is a sequence of identifier fields that will serve to create a unique copy of the object and create an ownership token between the object and the operating system.

7. The method of claim 6, wherein the DNA Pattern is selected from the properties of the computer system objects (DNA Objects) in the DNA Scope Set such that the DAN Pattern is unique across the DNA Domain when compared to other DNA Patterns.

8. The method of claim 6, wherein further comprises the step of storing the DNA Pattern in the EDSS.

9. The method of claim 1, further comprising the steps of the creation phase, which inserts the DNA Pattern into DNA Scope Set objects creating DNA Steganographic Objects.

10. The method of claim 9, wherein comprises the step of selecting DNA Objects from the DNA Domain to be protected.

11. The method of claim 9, wherein comprises the step of retrieving the DNA Pattern from the EDSS.

12. The method of claim 9, wherein comprises the step of encrypting the DNA Pattern.

13. The method of claim 9, wherein comprises the step of a steganographic process to embed the results of method 12 into the results of method 10 producing a DNA Steganographic Object.

14. The method of claim 9, wherein comprises the step of storing the results of method 13 in the system resource library.

15. The method of claim 14, further comprises the step of moving the original DNA Object off-line.

16. The method of claim 9, wherein comprises the step of storing control information into an EDSS file record relative to the DNA Steganographic Object so as to be able to extract the DNA Pattern from the DNA Steganographic Object and recreate the DNA Object.

17. The method of claim 1, further comprising the steps of the authentication phase, which extracts a DNA Pattern from the DNA Steganographic Object (the results of method 13) recreating the DNA Object.

18. The method of claim 17, wherein comprises the step of the operating system providing the intrusion detection system with an object name to be executed.

19. The method of claim 17, wherein comprises the step of searching the EDSS for a record containing a DNA Steganographic Object having the same name as the results of method 18.

20. The method of claim 17, wherein the object is rejected is the object name is not found on the EDSS.

21. The method of claim 17, wherein comprises the step of extracting control information from a record corresponding to the DNA Steganographic Object of the EDSS file.

22. The method of claim 17, wherein comprises the step of, given the control information from method 21, reversing the steganographic process of method 13 to extract the encrypted DNA Pattern.

23. The method of claim 22, further comprises the step of recreating the DNA Object.

24. The method of claim 22, further comprises the step of decrypting the DNA Pattern.

25. The method of claim 17, wherein comprises the step of retrieving the DNA Pattern definition from the EDSS file.

26. The method of claim 17, wherein comprises the step of comparing the results of method 24 with the results of method 25.

27. The method of claim 26, wherein further authenticates the object for execution if there is a match.

28. The method of claim 26, wherein further rejects the object if there is no match.
